(19) United States
(12) Patent Application Publication
(10) Pub. No.: US 2012/0229234 A1
(43) Pub. Date: Sep. 13, 2012

(54) SAFETY DEVICE

(75) Inventor: Mitsuyuki Wakabayashi, Yokosuka-shi (JP)

(73) Assignee: NIFCO INC., Yokohama-shi (JP)

(21) Appl. No.: 13/508,651

(22) PCT Filed: Nov. 10, 2010
(86) PCT No.: PCT/JP2010/070050

§ 371 Date: May 18, 2012

(30) Foreign Application Priority Data
Nov. 12, 2009 (JP) 2009-259256

(51) Int. Cl. H01H 50/64

(52) U.S. Cl. 335/71

(57) ABSTRACT

Contact terminals (24 and 26) are arranged on a support base (12) at a distance in a circumferential direction of a rotating drum (14). A conductive part (30) extending at least for a distance between the contact terminals (24 and 26) in the circumferential direction is provided on a perimeter surface (14A) of the rotating drum (14) in correspondence with the positions of arrangement of the contact terminals (24 and 26). The rotating drum (14) is rotated in the circumferential direction in a state in which the perimeter surface (14A) has been brought into contact with the contact terminals (24 and 26), and the conductive part (30) is brought into contact with the contact terminals (24 and 26), whereby switching between conducting and non-conducting is performed.

### TECHNOLOGICAL FIELD

The present invention relates to a safety device, and relates specifically to a safety device for protecting a user from electrical shock, leakage of electricity, and the like.

### BACKGROUND TECHNOLOGY

Vehicles that run by combining drive power of an engine and an electric motor (so-called “hybrid vehicles”) and vehicles that run on drive power of an electric motor (so-called “electric automobiles”) have been practically used in recent years.

In these hybrid vehicles and electric automobiles, a large-capacity battery is carried as a power supply for the electric motor, and electricity from the battery is converted to high-voltage by a DC-DC converter or other inverter to be supplied to the electric motor. In hybrid vehicles and electric automobiles, a large-capacity smoothing capacitor is provided on the power line in the aim of reducing noise and stabilizing voltage.

In the case when a collision or other accident occurs in a vehicle carrying such electrical circuit, there is a need to protect a passenger or a rescuer from electrical shock, electrical leakage, or other secondary accident.

Therefore, technology is disclosed in Japanese Patent Publication No. 2006-224772, in which a discharge relay is provided as a safety device for discharging electricity charged in the smoothing capacitor, and the discharge relay is turned on by control from a controller when a collision occurs, whereby the electricity charged in the smoothing capacitor is discharged.

### DISCLOSURE OF THE INVENTION

### Problem to be Solved by the Invention

Incidentally, in the case when a discharge relay is used as a safety device, as in the technology in Japanese Patent Publication No. 2006-224772, there is a need actually to turn the discharge relay on in order to confirm whether the safety device is actually operative.

However, in the case when the discharge relay is turned on, electricity charged in the smoothing capacitor actually flows and there is a tendency for the electrical circuit to break. Therefore, a confirmation of operation as to whether the safety device is operative is difficult to perform.

An object of the present invention is to provide a safety device in which confirmation of operation can be performed easily.

### Means for Solving the Problem

In order to achieve the abovementioned object, the safety device of a first aspect of the present invention comprises a first member having at least one set of two contact terminals in which the two contact terminals are arranged separately to each other in one direction; a second member including a contact surface contacting with said two contact terminals and formed from an insulator, and a conductive part of a conductor having a length of at least a space between the two contact terminals in said one direction and provided on said contact surface for each set in correspondence with positions of arrangement of the two contact terminals; a moving mechanism moving at least one of said first member and said second member in said one direction in a state in which said contact surface is contacting with said two contact terminals; and a control unit controlling said moving mechanism to move at least one of said first member and said second member in said one direction under a predetermined condition.

In the first aspect of the present invention, two contact members are arranged in at least one group at a distance in one direction on a first member. Also, in the first aspect, a contact surface for contacting with the two contact terminals is formed with an insulator on a second member, and a conductive part using a conductor extending at least the distance between the two contact terminals in the one direction is provided on the contact surface for each group in correspondence with the positions of arrangement of the two contact terminals. Furthermore, in the first aspect, there is provided a moving mechanism for moving at least one of the first member and the second member in the one direction in a state in which the contact surface contacts with the two contact terminals.

Also, in the first aspect of the present invention, the moving mechanism is controlled by a control unit so that at least one of the first member and the second member moves in the one direction under a predetermined condition.

Thus, according to the first aspect of the present invention, the two contact members are arranged at a distance in one direction on the first member, the conductive part using a conductor extending at least the distance between the two contact terminals in the one direction is provided on the contact surface formed with an insulator on the second member in correspondence with the positions of arrangement of the two contact terminals, and at least one of the first member and the second member is moved in the one direction in a state in which the contact surface contacts with the two contact terminals, whereby switching of conducting and non-conducting between the two contact terminals is performed. Therefore, confirmation of operation can be performed easily by confirming whether either of the first member and the second member is movable in the one direction.

The present invention may be such that, as in a second aspect of the present invention, said second member is made as a round columnar member that has a round columnar form, is axially supported to be rotatable, and has said conductive part formed in a circumferential direction of a perimeter surface; said two contact terminals are arranged at a distance in the circumferential direction of said perimeter surface; and said moving mechanism rotates said round columnar member in the circumferential direction.

Also, the present invention may be such that, as in a third aspect of the present invention, the two contact terminals of any one group are connected in parallel to a smoothing capacitor for smoothing power supplied to a motor for generating drive power to drive a vehicle; and said control unit is used for controlling the moving mechanism so that at least one of said first member and said second member is moved in the one direction and said conductive part contacts with the two contact terminals connected in parallel to the capacitor in a case when a collision of the vehicle has been sensed by a sensor unit for sensing a collision of the vehicle.

Also, the present invention may be such that, as in a fourth aspect of the present invention, said two contact terminals are arranged in a plurality of groups on said first member and are connected in parallel to respectively different electrical circuits; and said conductive part is provided on said second member so that the space between the two contact terminals connected in parallel to each electrical circuit becomes in a conducting state in an order of ascending priority to be discharged when at least one of said first member and said second member has been moved in said one direction.

Also, the present invention may be such that, as in a fifth aspect of the present invention, at least one of said first member and said second member is manually movable in said one direction.

### Effect of the Invention

According to the present invention as described above, an effect is obtained such that confirmation of operation can be performed easily.

### BRIEF DESCRIPTION OF THE DRAWINGS

FIG. 1 is a perspective view illustrating the general configuration of the safety device according to an embodiment.

FIG. 2 is a plan view illustrating the general configuration of the safety device according to the embodiment.

FIG. 3A is a diagram illustrating one example of a state of contact of a conductive part with contact terminals.

FIG. 3B is a diagram illustrating one example of a state of contact of a conductive part with contact terminals.

FIG. 4A is a diagram illustrating a change of state of contact of a conductive part with contact terminals accompanying rotation of the rotating drum of the safety device according to the embodiment.

FIG. 4B is a diagram illustrating a change of state of contact of a conductive part with contact terminals accompanying rotation of the rotating drum of the safety device according to the embodiment.

FIG. 4C is a diagram illustrating a change of state of contact of a conductive part with contact terminals accompanying rotation of the rotating drum of the safety device according to the embodiment.

FIG. 4D is a diagram illustrating a change of state of contact of a conductive part with contact terminals accompanying rotation of the rotating drum of the safety device according to the embodiment.

FIG. 5 is a circuit configuration diagram simply illustrating the configuration of the electrical system of a vehicle according to the embodiment.

FIG. 6 is a flow chart illustrating the flow of processing of the discharge control processing program according to the embodiment.

FIG. 7 is a perspective view illustrating the configuration of the safety device according to another embodiment.

FIG. 8 is a perspective view illustrating the configuration of the safety device according to another embodiment.

### PREFERRED EMBODIMENTS OF THE INVENTION

Embodiments of the present invention are described in detail below while referring to the drawings.

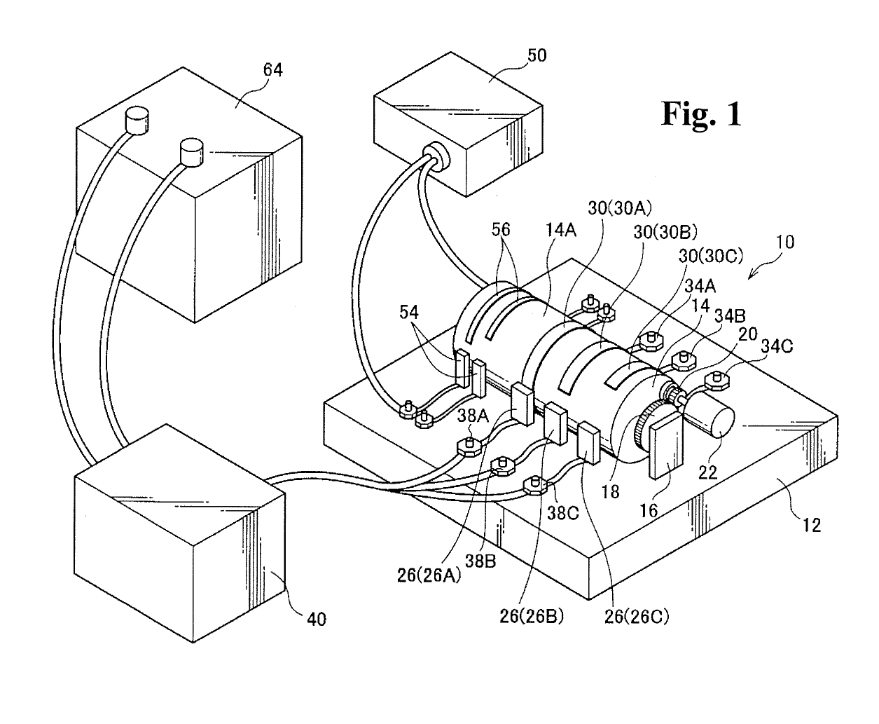

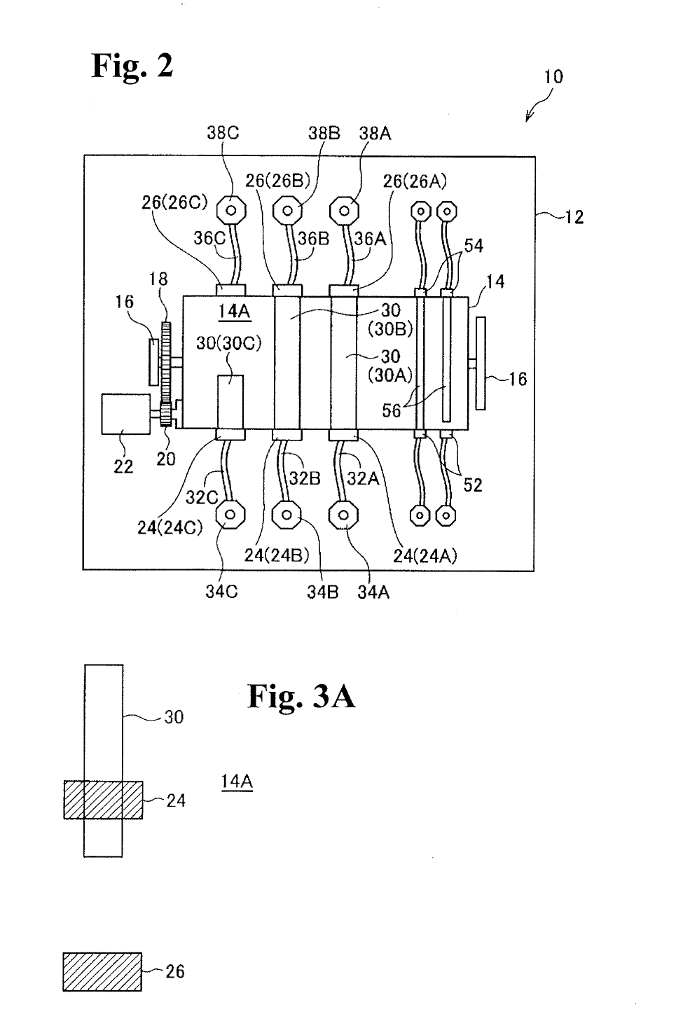

As illustrated in FIGS. 1 and 2, the safety device 10 according to the present embodiment has a flat board-form support base 12 formed with an insulator, and a round columnar rotating drum 14 formed with an insulator. In the present embodiment, the support base 12 corresponds to the first member, and the rotating drum 14 corresponds to the second member.

The rotating shaft of the rotating drum 14 is supported by a pair of support parts 16 placed upright on the support base 12, so that the rotating shaft of the rotating drum 14 and the support base 12 are in parallel. A flat gear 18 is fixed to the rotating shaft of the rotating drum 14.

A motor 22, having a flat gear 20 fixed to a rotating shaft, is provided on the support base 12. The motor 22 is fixed in a position for the flat gear 18 and the flat gear 20 to engage. The rotating drum 14 rotates by driving the motor 22 to rotate. In the present embodiment, the motor 22 corresponds to the moving mechanism.

Also, two contact terminals 24 and 26 are arranged on the support base 12 at a distance in the circumferential direction of the rotating drum 14 as illustrated in FIG. 2. In the safety device 10 according to the present embodiment, three groups (A, B, C) of contact terminals 24 and 26 are provided in order to enable switching of conducting and non-conducting for three electrical circuits. The contact terminals 24 and 26 are arranged for each group so as to contact at identical positions with respect to the direction of the rotating shaft of the rotating drum 14 and at different positions on a perimeter surface 14A of the rotating drum 14 at distances in the circumferential direction thereof. In the present embodiment, the perimeter surface 14A corresponds to the contact surface.

A conductive part 30 using copper or another conductor is provided on the perimeter surface 14A of the rotating drum 14 for each group (A, B, and C) of contact terminals 24 and 26, extending at least the distance between the contact terminals 24 and 26 in the perpendicular direction in correspondence with the positions of arrangement of the contact terminals 24 and 26.

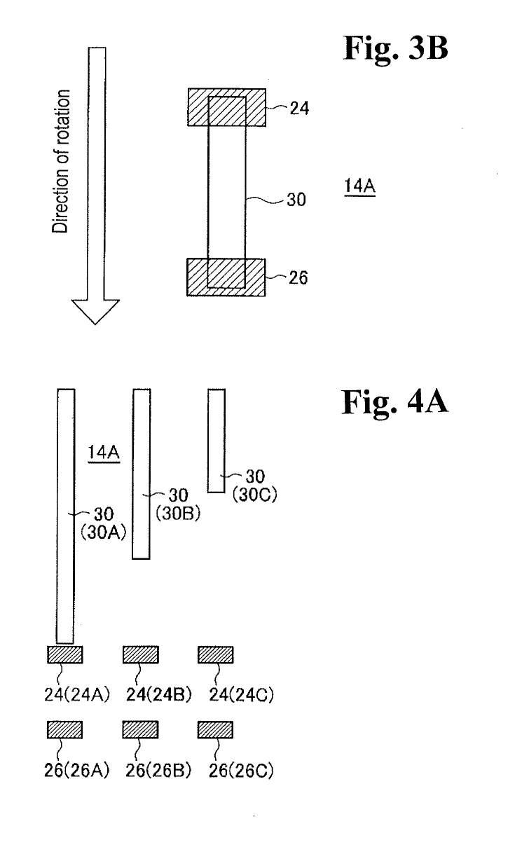

Thus, by providing the conductive part 30 extending at least only the distance between the contact terminals 24 and 26 on the perimeter surface of the rotating drum 14, the space between the contact parts 24 and 26 becomes in an electrically non-conducting state in a state in which the conductive part 30 is not contacting with the contact terminals 24 and 26 as illustrated in FIG. 3A. Also, the space between the contact terminals 24 and 26 becomes in an electrically conducting state in a state in which the rotating drum 14 has been rotated so that the conductive part 30 is contacting with the contact terminals 24 and 26 as illustrated in FIG. 3B. Also, a group to become in a conducting state and a group to become in a non-conducting state can be provided by changing the position and length on the perimeter surface 14A and in the circumferential direction of the contact part 30 of each group. The description is given below, assigning A, B, and C after each symbol in order to distinguish the contact terminals 24 and 26 and conductive part 30 of each group A, B, and C.

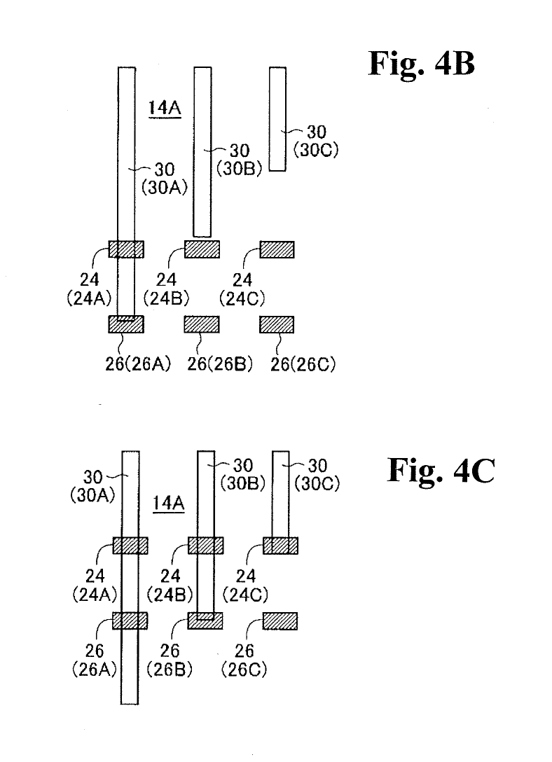

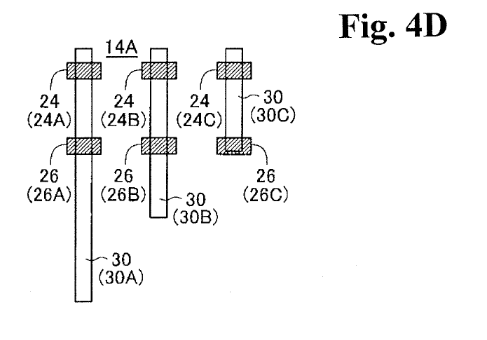

In the safety device 10 according to the present embodiment, the initial position is the position of rotation of the rotating drum 14 in which the contact terminals 24 and 26 and the conductive part 30 of each group A, B, and C are not in contact and in the non-conducting state as illustrated in FIG. 4A. Also, in the safety device 10 according to the present embodiment, the position and length in the circumferential direction of each conductive part 30 are predetermined so that the contact terminals 24A and 26A and the conductive part 30A contacts and only the group A becomes in the conducting state when the rotating drum 14 is rotated a prescribed first angle (for example, 45 degrees) in the one direction from the initial position as illustrated in FIG. 4B; the contact terminals 24B and 26B and the conductive part 30B further come in contact and the groups A and B become in the conducting state when the rotating drum 14 is rotated a prescribed second angle greater than the first angle (for example, 90 degrees) in the one direction from the initial position as illustrated in FIG. 4C; and the contact terminals 24C and 26C and the conductive part 30C further come in contact and the groups A, B, and C become in the conducting state when the rotating drum 14 is rotated a prescribed third angle greater than the second angle (for example, 135 degrees) in the one direction from the initial position as illustrated in FIG. 4D.

The contact terminals 24A, 24B, and 24C respectively are connected by way of wires 32A, 32B, and 32C to external connection terminals 34A, 34B, and 34C. The contact terminals 26A, 26B, and 26C respectively are connected by way of wires 36A, 36B, and 36C to external connection terminals 38A, 38B, and 38C.

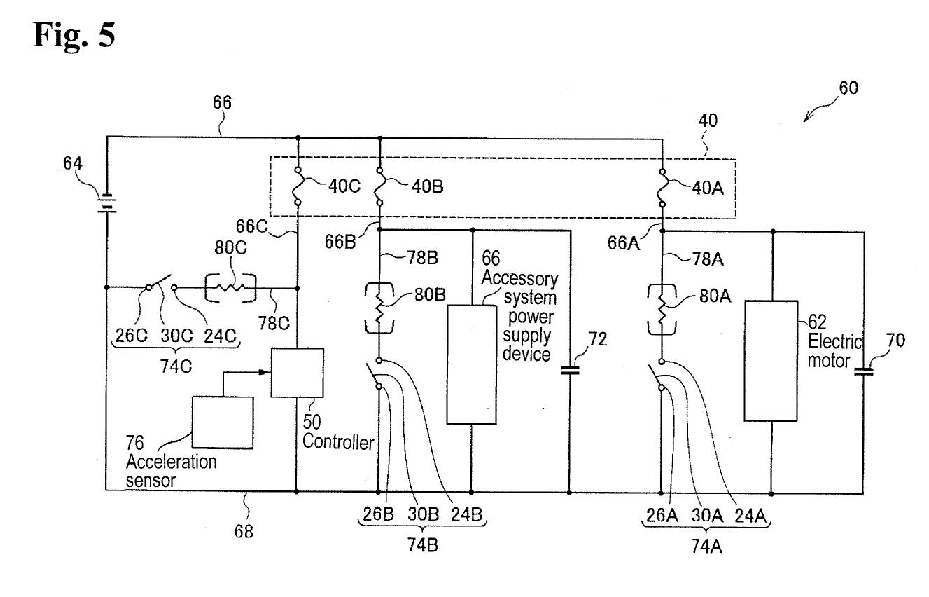

In FIG. 1, the connection terminals 38A, 38B, and 38C are connected by way of three wires to a fuse box 50 in which are installed fuses 40A, 40B, and 40C (see FIG. 5) to be described. The fuse box 40 may be connected to the connection terminals 34A, 34B, and 34C. The fuse box 40 is connected to a battery 64.

Also, the motor 22 is connected to the controller 50, and is driven to rotate by control signals from the controller 50. In the present embodiment, the controller 50 corresponds to the control unit.

Also, in the safety device 10 according to the present embodiment, two groups of position detecting terminals 52 and 54 are provided in corresponding positions on the support base 12 at one end in the direction of the rotating shaft of the rotating drum 14 in order to detect the angle of rotation of the rotating drum 14. Also, in the safety device 10 according to the present embodiment, two position detecting conductive parts 56 are provided on the perimeter surface 14A of the rotating drum 14 at one end in the direction of the rotating shaft. The two position detecting conductive parts 56 are such that the positions and lengths in the circumferential direction of the two position detecting conductive parts 56 are predetermined so that one group of position detecting contact terminals 52 and 54 becomes in the conducting state when the rotating drum 14 is rotated the abovementioned first angle from the initial position, and the two groups of position detecting contact terminals 52 and 54 respectively become in the conducting state when the rotating drum 14 is rotated the abovementioned second angle from the initial position. The two groups of position detecting contact terminals 52 and 54 respectively are connected to the controller 50.

The controller 50 is made capable of detecting whether the angle of rotation of the rotating drum 14 is the first angle or the second angle by ascertaining the conducting states of the position detecting terminals 52 and 54.

A case in which the safety device 10 according to the present embodiment is applied as a safety device during collision of a hybrid vehicle, electric automobile, or other vehicle 60 having a power source using an electrical system is next described.

FIG. 5 illustrates one example of a circuit configuration to simply illustrate the electrical system of a vehicle 60. In FIG. 5, a portion of the circuit including a converter for transforming voltage or an inverter for converting DC voltage into AC voltage is omitted in order to simplify the description.

The vehicle 60 has an electric motor 62 serving also as a power source for driving the vehicle 60, a large-capacity battery 64 serving as a power supply for the electric motor 62, an accessory system power supply device 66 for supplying power to vehicle-mounted lamps, a car air conditioner, a car navigation system, and other accessory systems, and a controller 50 for controlling these.

The electric motor 62, accessory system power supply device 66, and controller 50 are connected in parallel to power supply lines 66 and 68, which are supplied with power from the battery 64. Also, a large-capacity smoothing capacitor 70 is connected in parallel to the electric motor 62 in the aim of reducing noise and stabilizing voltage. Also, a capacitor 72 is connected in parallel to the accessory system power supply device 66 in the aim of reducing noise and stabilizing voltage.

In the present embodiment, the power supply line 66 branches in parallel to wires 66A, 66B, and 66C, and supplies power to the electric motor 62, accessory system power supply device 66, and controller 50. Fuses 40A, 40B, and 40C respectively are provided on the wires 66A, 66B, and 66C.

Also, in the present embodiment, the space between the fuse 40A on the wire 66A and the electric motor 62 is branched and connected to an external connection terminal 34A. Also, in the present embodiment, the space between the fuse 40B on the wire 66B and the accessory system power supply device 66 is branched and connected to an external connection terminal 34B. Furthermore, in the present embodiment, the space between the fuse 40C on the wire 66C and the controller 50 is branched and connected to an external connection terminal 34C. Also, in the present embodiment, the power supply line 68 is branched and connected respectively to external connection terminals 38A, 38B, and 38C. By this, the contact terminal 24A, contact terminal 26A, and conductive part 30A of the safety device 10 function as a switch 74A connected in parallel to the electric motor 62. Also, the contact terminal 24B, contact terminal 26B, and conductive part 30B function as a switch 74B connected in parallel to the accessory system power supply device 66. Furthermore, the contact terminal 24C, contact terminal 26C, and conductive part 30C function as a switch 74C connected in parallel to the controller 50.

A sensor unit for sensing collision of the vehicle 60, for example, an acceleration sensor 76 is connected to the controller 50 to detect whether the vehicle 60 has collided based on acceleration sensed by the acceleration sensor 76.

The operation of the safety device 10 according to the present embodiment is described next.

In the controller 50, it is determined as to whether a collision or other accident has occurred based on acceleration sensed by the acceleration sensor 76. Also, in the controller 50, the accident situation is judged based on the sensed acceleration and the circuits are broken in stages. In the present embodiment, it is judged that a collision has occurred in the case when acceleration at or above a predetermined value at which a collision can be judged to have occurred is sensed. Also, in the present embodiment, the accident injury situation is judged to be greater as the sensed acceleration is greater, and the range of acceleration is divided into minor accident, moderate accident, and major accident. A first threshold between minor accident and moderate accident and a second threshold between moderate accident and major accident are predetermined, and are stored in advance in a flash memory, ROM, or other memory unit provided in the controller 50. In the controller 50, in the case when it is judged that a collision has occurred, the sensed acceleration is compared with the first threshold and second threshold, it is identified as to whether any of minor accident, moderate accident, or major accident has occurred, and the electricity is discharged in an order from the electrical circuits of ascending priority to be discharged in accordance with the accident situation.

In the present embodiment, the priority of the electrical circuits to be discharged is in the order of the electric motor 62 portion, the accessory system power supply device 66 portion, and the controller 50. In the present embodiment, in the case when a minor accident has occurred, the electricity charged in the electric motor 62 portion is discharged. In the case when a moderate accident has occurred, the electricity charged in the electric motor 62 portion and the accessory system power supply device 66 portion is discharged. In the case when a major accident has occurred, the electricity charged in the electric motor 62 portion, the accessory system power supply device 66 portion, and the controller 50 is discharged.

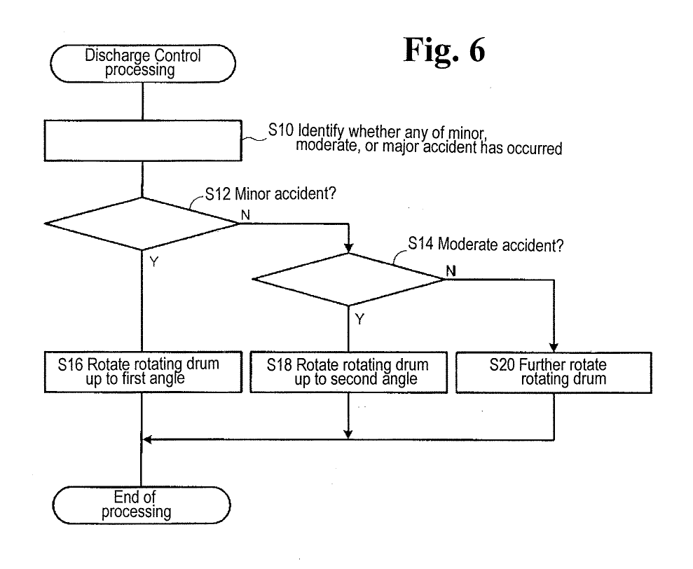

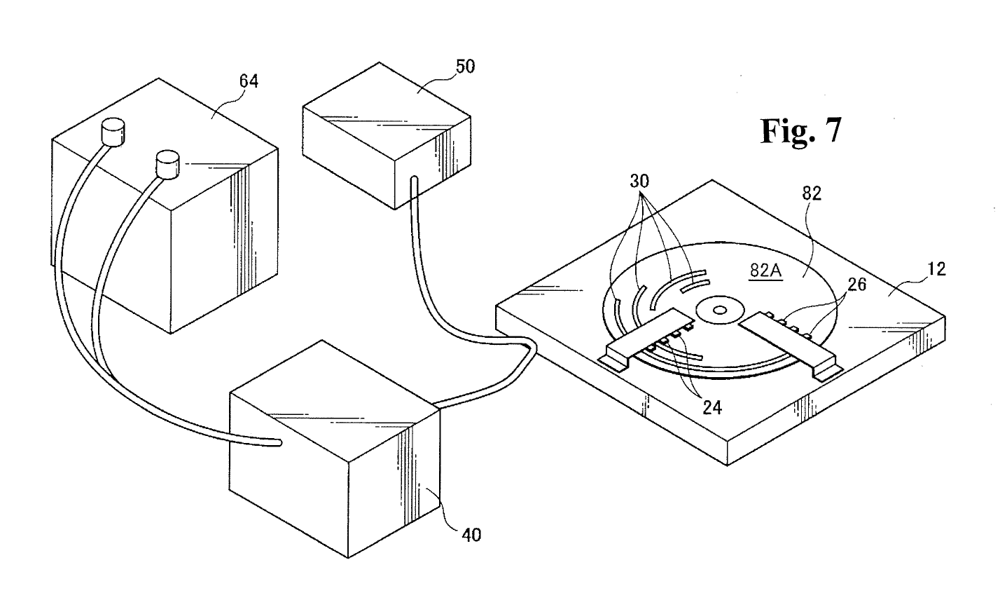

FIG. 6 illustrates a flow chart illustrating the flow of processing of a discharge control processing program executed in the controller 50 in the case when an acceleration at or above the predetermined value is sensed by the acceleration sensor 76. The program is stored advance in a flash memory, ROM, or other memory unit provided in the controller 50.

In step S10 in FIG. 6, the sensed acceleration is compared with the first threshold and second threshold, and it is identified as to whether any of minor accident, moderate accident, or major accident has occurred.

In the next step S12, it is determined as to whether the accident having occurred is a minor accident, the process moves to step S16 in the case of an affirmative determination, and the process moves to step S14 in the case of a negative determination.

In step S14, it is determined as to whether the accident is a moderate accident, the process moves to step S18 in the case of an affirmative determination, and the process moves to step S20 in the case of a negative determination.

According to the determination in these steps S12 to S14, the process moves to step S16 in the case when a minor accident has occurred, the process moves to step S18 in the case when a moderate accident has occurred, and the process moves to step S20 in the case when a major accident has occurred.

In step S16, the electric motor 62 is driven to rotate up to the position where one group of position detecting contact terminals 52 and 54 is detected to be in the conducting state. By this, the rotating drum 14 rotates the first angle and stops. When the rotating drum 14 rotates up to the first angle, the conductive part 30A contacts the contact terminals 24A and 26A and only group A becomes in the conducting state (the switch 74A in FIG. 5 becomes in the conducting state). By this, the electricity charged in the smoothing capacitor 70 connected in parallel to the electric motor 62 is discharged by way of the switch 74A, and the fuse 40A is broken and the supply of power from the battery 64 to the electric motor 62 portion is cut.

Meanwhile, in step S18, the electric motor 62 is driven up to the position where the two groups of position detecting contact terminals 52 and 54 are detected to be in the conducting state. By this, the rotating drum 14 rotates the second angle and stops. When the rotating drum 14 rotates up to the second angle, the contact terminals 24A and 26A and conductive part 30A, and contact terminals 24B and 26B and conductive part 30B respectively contact and the groups A and B come to the conducting state (the switches 74A and 74B in FIG. 5 become in the conducting state). By this, the electricity charged in the smoothing capacitor 70 connected in parallel to the electric motor 62 is discharged by way of the switch 74A, and the electricity charged in the capacitor 72 connected in parallel to the accessory system power supply device 66 is discharged by way of the switch 74B. Also, the fuses 40A and 40B are cut and the supply of power from the battery 64 to the electric motor 62 portion and accessory system power supply device 66 portion is cut.

Meanwhile, in step S20, the electric motor 62 is further driven to rotate. By this, when the rotating drum 14 rotates up to the third angle, the contact terminals 24A and 26A and conductive part 30A, contact terminals 24B and 26B and conductive part 30B, and contact terminals 24C and 26C and conductive part 30C respectively contact and the groups A, B, and C become in the conducting state (the switches 74A, 74B, and 74C in FIG. 5 become in the conducting state). By this, the electricity charged in the smoothing capacitor connected in parallel to the electric motor 62 is discharged by way of the switch 74A, the electricity charged in the capacitor 72 connected in parallel to the accessory system power supply device 66 is discharged by way of the switch 74B, and the electricity charged in the controller 50 is discharged by way of the switch 74C. Also, the fuses 40A, 40B, and 40C are cut and the supply of power from the battery 64 to the electric motor 62 portion, accessory system power supply device 66 portion, and controller 60 is cut.

A large current flows instantaneously in the case when the switches 74A, 74B, and 74C have become in the conducting state. Therefore, in the present embodiment, it is preferable that resistors 80A, 80B, and 80C respectively be provided on the wires 78A, 78B, and 78C on which the switches 74A, 74B, and 74C are provided, as illustrated in FIG. 5, so that the instantaneous flow of a large current is suppressed.

According to the present embodiment as described above, switching of conducting and non-conducting in a plurality of locations can be performed with one safety device, and the combination of conducting and non-conducting can be controlled by changing the position on the perimeter surface and the length in the circumferential direction of each conductive part 30.

Also, according to the present embodiment, because switching of conducting and non-conducting between the two contact terminals 24 and 26 is performed by physical rotation of the rotating drum 14 by drive power of the motor 22, confirmation of operation can be easily performed by actually rotating the rotating drum 14 and stopping the rotation before reaching the first angle.

Also, according to the present embodiment, switching of conducting and non-conducting in a plurality of locations can be performed by a simple operation of rotating the rotating drum 14 in one direction by drive power of the motor 22.

Also, according to the present embodiment, because the conductive part 30 is provided so that the space between the contact terminals 24 and 26 becomes in the conducting state in an order of ascending priority to be discharged when the rotating drum 14 is rotated in the one direction, the electricity can be discharged in the order of ascending priority by a simple operation of rotating the rotating drum 14 in the one direction.

Furthermore, according to the present embodiment, because the configuration is such that the drive power of the motor 22 is transmitted to the rotating shaft of the rotating drum 14 by the combination of the flat gear 18 and flat gear 20, manual rotation of the rotating drum 14 also becomes possible, and switching of conducting and non-conducting can be performed by rotating by the user rather than by the drive power of the motor 22.

In the abovementioned embodiment, a case was described in which the switch 74A becomes in the conducting state when the rotating drum 14 is rotated up to the first angle, the switch 74A and switch 74B become in the conducting state when the rotating drum 14 is rotated up to the second angle, and the switch 74A, switch 74B, and switch 74C become in the conducting state when the rotating drum 14 is rotated up to the third angle, but the present invention is not limited to this. For example, the position and length on the perimeter surface and in the circumferential direction of the conductive part 30 may be adjusted so that only the switch 74A becomes in the conducting state in a range from the first angle to less than the second angle of the rotating drum 14, only the switch 74B becomes in the conducting state in a range from the second angle to less than the third angle of the rotating drum 14, and only the switch 74C becomes in the conducting state in a range from the third angle and beyond of the rotating drum 14.

Also, in the abovementioned embodiment, a case was described in which the rotating drum 14 was formed with an insulator, but the present invention is not limited to this. The rotating drum 14 should be such that the perimeter surface 14A is insulated, and, for example, the perimeter surface 14A may be insulated by laminating the perimeter surface 14A with an insulator.

Also, in the abovementioned embodiment, a case was described in which the rotating drum 14 is rotated, but the present invention is not limited to this. For example, the invention may be as illustrated in FIG. 7, in which a disk-form member 82 is formed in a disk form using an insulator, conductive parts 30 using conductors are formed respectively in arc forms from the center with different radii on the surface of the disk portion 82A of the disk-form member 82, two contact terminals 24 and 26 are provided on the support base 12 at positions being the same distances as the distances of the conductive parts 30 from the center of the disk-form member 82, and switching of conducting and non-conducting is performed by rotating the disk-form member 82 with the center as axis.

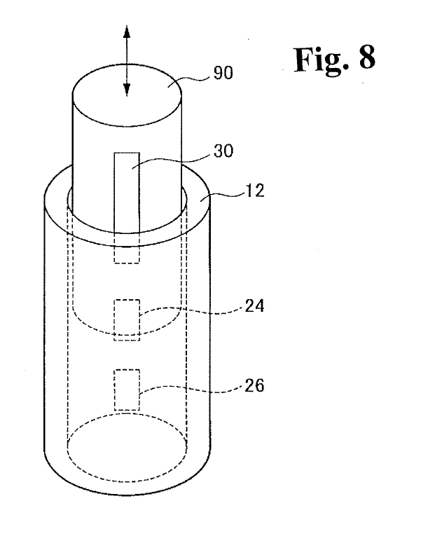

Also, for example, the invention may be as illustrated in FIG. 8, in which a round columnar member 90 is formed in a round columnar form using an insulator, conductive parts 30 using conductors are provided in the central axial direction of the round column respectively at different positions in the circumferential direction on the surface of the round columnar portion, a support base 12 is formed in a cylindrical form being hollow and being capable of receiving the round columnar member 90 on the inner perimeter surface side, two contact terminals 24 and 26 are provided on the inner perimeter surface of the support base 12 following the central axial direction in positions opposite the conductive part 30, and switching of conducting and non-conducting is performed by moving at least one of the round columnar member 90 and the support base 12 in the central axial direction, for example, using a solenoid or an actuator.

Also, in the abovementioned embodiment, a case was described in which the acceleration unit 76 was used as a sensor unit for sensing collision of the vehicle 60, but the present invention is not limited to this. For example, an air bag sensor provided in the vehicle 60 may be used. Also, a collision may be sensed directly by a collision sensor installed inside the front bumper of the vehicle 60 to output a signal upon a collision.

Also, in the abovementioned embodiment, a case was described in which the position of rotation of the rotating drum 14 is detected using two groups of position detecting contact terminals 52 and 54 and two position detecting conductive parts 56, but the present invention is not limited to this. For example, in the case when a servo motor is used as the motor 22, the position of rotation of the rotating drum 14 can be identified by counting the clock count of the drive signals supplied from the controller 50 to the motor 22. Also, the position of rotation of the rotating drum 14 may be detected by providing a rotary encoder, or the like, on the rotating shaft of the rotating drum 14.

Also, in the abovementioned embodiment, a case was described in which the safety device 10 is applied as a safety device for use during a collision of a vehicle 60 having a power source using an electrical system, but the present invention is not limited to this.

What is claimed is:

1. A safety device, comprising:
a first member having at least one set of two contact terminals in which the two contact terminals are arranged separately to each other in one direction;
a second member including a contact surface contacting with said two contact terminals and formed from an, insulator, and a conductive part of a conductor having a length of at least a space between the two contact terminals in said one direction and provided on said contact surface for each set in correspondence with positions of arrangement of the two contact terminals;
a moving mechanism moving at least one of said first member and said second member in said one direction in a state in which said contact surface is contacting with said two contact terminals; and
a control unit controlling said moving mechanism to move at least one of said first member and said second member in said one direction under a predetermined condition.

2. A safety device according to claim 1, wherein said second member is a round columnar member having a round columnar form supported axially and rotatably, and having said conductive part formed in a circumferential direction of a perimeter surface;
said two contact terminals are arranged at a distance in the circumferential direction of said perimeter surface; and
said moving mechanism rotates said round columnar member in the circumferential direction.

3. A safety device according to claim 1, wherein the two contact terminals of one set are connected in parallel to a smoothing capacitor for smoothing a power supplied to a motor for generating drive power to drive a vehicle; and
when a collision of the vehicle has been detected by a sensor unit detecting the collision of the vehicle, said control unit moves at least one of said first member and said second member in said one direction, and controls said moving mechanism to contact said two contact terminals and said conductor connected in parallel to said capacitor.

4. A safety device according to claim 1, wherein said two contact terminals are disposed in a plurality of sets on said first member and each connected in parallel to different electrical circuits; and
said conductive part is provided on said second member so that the space between the two contact terminals connected in parallel to each electrical circuit becomes in a conducting state in an order of priority to be discharged when at least one of said first member and said second member has been moved in said one direction.

5. A safety device according to claim 1, wherein at least one of said first member and said second member is manually movable in said one direction.
